(19) United States
(12) Patent Application Publication
(10) Pub. No.: US 2013/0208000 A1
(43) Pub. Date: Aug. 15, 2013

(54) ADJUSTABLE ACTIVITY CAROUSEL

(71) Applicants: Aylin Uysal, San Francisco, CA (US); Sally Baggett, Healdsburg, CA (US); Chun Yi Chen, Belmont, CA (US)

(72) Inventors: Aylin Uysal, San Francisco, CA (US); Sally Baggett, Healdsburg, CA (US); Chun Yi Chen, Belmont, CA (US)

(73) Assignee: Oracle International Corporation, Redwood Shores, CA (US)

(21) Appl. No.: 13/371,292

(22) Filed: Feb. 10, 2012

(51) Int. Cl. G09G 5/00

(52) U.S. Cl. 345/629; 345/676; 345/660

(57) ABSTRACT

A system and method for facilitating selectively displaying data. An example method includes organizing data into one or more data objects represented by one or more graphical display elements; displaying the one or more graphical display elements in a band of plural display elements; and providing a first user option to simultaneously adjust spacing between each of the plural display elements in the band. In a specific embodiment, the method further includes providing user options to convert the band of display elements into a carousel view or to a filmstrip view by adjusting the spacing, and to switch between display of graphical display elements in a grid and display of graphical display elements in the band.

### BACKGROUND

The present application relates to software and more specifically to user interface designs and methods for facilitating displaying and interacting with information.

Software for facilitating displaying and interacting with information is employed in various demanding applications, including display of search results, representations of social networks, website presentations of products for sale, depictions of objects in a database, and so on. Such applications often demand user interface display mechanisms and data organization techniques that minimize clutter and enable efficient and rapid access to relevant information. Efficient mechanisms for displaying or graphically presenting information in a user interface are becoming increasingly important with the proliferation of mobile computing devices, such as smartphones, where screen space is limited.

An example user interface feature for displaying visual elements, such as graphical representations of data objects, includes a swim lane, also called a filmstrip presentation. A swim lane may include a linear horizontal listing of display elements coupled with a scroll bar or arrows on either side of the swim lane. The scroll bar or arrows enable scrolling the displayed elements horizontally.

In a typical swim lane, the numbers of displayed elements are often substantially limited by available screen space, which can be particularly problematic for mobile computing implementations. The displayed elements are typically adjacent to each other, which may further limit the number of elements that can be simultaneously displayed.

To increase the numbers of simultaneously displayed elements, display elements may be stacked or cascaded, or they may be displayed in vertically scrollable list or grid. However, stacked or cascaded views typically obscure display elements, which are positioned behind others. Conventional list or grid views may occupy undesirably large areas of a user interface display screen.

### SUMMARY

An example method facilitates selectively displaying data. The example method includes organizing data into one or more data objects represented by one or more graphical display elements (e.g., icons, windows, dialog boxes, buttons, etc.); displaying the one or more graphical display elements in a band of plural display elements; and providing a first user option to simultaneously adjust spacing between each of the plural display elements in the band.

In a specific example embodiment, the first user option enables a user to sufficiently reduce the spacing between graphical display elements to cause overlap of one or more of the plural display elements within the display band. The first user option further enables a user to sufficiently adjust element spacing to cause no overlap between one or more of the plural display elements. Hence, the first user option enables a user to convert the band of display elements into a carousel view or into a filmstrip view by adjusting the spacing.

Additional user options include: an option enabling a user to display one or more of the plural display elements in a grid; and option to switch between display of graphical display elements in a grid and display of graphical display elements in the band; and an option to hide one or more of the graphical display elements from view in the grid.

The option to hide graphical display elements may be implemented via a drop zone user interface control. Upon selection of the drop zone user interface control, previously hidden display elements may be shown in a drop zone section. A graphical display element may be automatically hidden from a grid or a band when the graphical display element is dragged from the gird or band to the drop zone.

Hence, certain embodiments disclosed herein provide user options to facilitate displaying and browsing through a set of items, such as by integrating adjustable carousel views and the grid views. A slider or other user interface control may enable a user to adjust the spacing between the items in the carousel view. A toggle button or other mechanism may facilitate quickly switching between the carousel and grid views, which may be personalized.

Hence, certain embodiments discussed herein may facilitate efficiently displaying and organizing data or representations thereof to facilitate rapid access thereto while minimizing clutter and use of display screen space. User options for controlling icon (e.g., display element) spacing, ordering, and hiding, and for quickly switching between grid and carousel views may offer users enhanced control and flexibility over how and what data is displayed, thereby potentially enhancing work efficiency.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a diagram illustrating a first example embodiment of a system for facilitating displaying and organizing data via an adjustable activity carousel.

FIG. 2 is a first example user interface display screen illustrating an adjustable activity carousel in a carousel or stacked mode, wherein spacing between visual elements in the carousel has been minimized via an adjustable slider.

FIG. 3 is a second example user interface display screen illustrating the adjustable activity carousel in a swim lane or flat mode, wherein spacing between visual elements in the carousel has been maximized via the adjustable slider.

FIG. 4 is a third example user interface display screen illustrating visual elements in a grid view after selection of a grid-view tab from the user interface display screen of FIG. 2 or 3.

FIG. 5 is a fourth example user interface display screen illustrating a drop zone, which appears after selection of a drop zone button or tab from the user interface display screen of FIG. 4.

FIG. 6 is a flow diagram of an example method adapted for use with the embodiments of FIGS. 1-5.

### DETAILED DESCRIPTION OF EMBODIMENTS

Although the description has been described with respect to particular embodiments thereof, these particular embodiments are merely illustrative, and not restrictive.

For example, while various embodiments herein are discussed with respect to user interface displays suitable for desktop implementations, embodiments are not limited thereto. Various embodiments disclosed herein may be adapted for use with virtually any computer based display, including smart phone displays, tablet displays, and so on.

Furthermore, while various user interface controls, such as buttons, tabs, sliders, and so on, are shown, other types of user interface controls may be employed in addition to or instead of such controls, without departing from the scope of the present teachings. For example, while a slider for adjusting spacing between visual elements in a swim lane or filmstrip display may be suitable for desktop implementations that employ computer mice, other implementations, such as those employing touch screens, may omit the slider, instead relying upon finger motions on the touch screen surface to enable spacing adjustments between visual display elements.

For the purposes of the present discussion, a visual display element, also called a visual element or a graphical display element, may be any icon, visualization, window, dialog box, or other graphical or visual representation of a computing object, where the visual representation may be presented on a display screen, projected, or otherwise displayed. A computing object may be any grouping of or collection of data and/or functionality associated with the data. Examples of objects include database records of employees, records or tables of customers, and so on. The terms ‘graphical display element’ and ‘visual element’ are employed interchangeably herein.

For clarity, certain well-known components, such as hard drives, processors, operating systems, power supplies, and so on, have been omitted from the figures. However, those skilled in the art with access to the present teachings will know which components to implement and how to implement them to meet the needs of a given application.

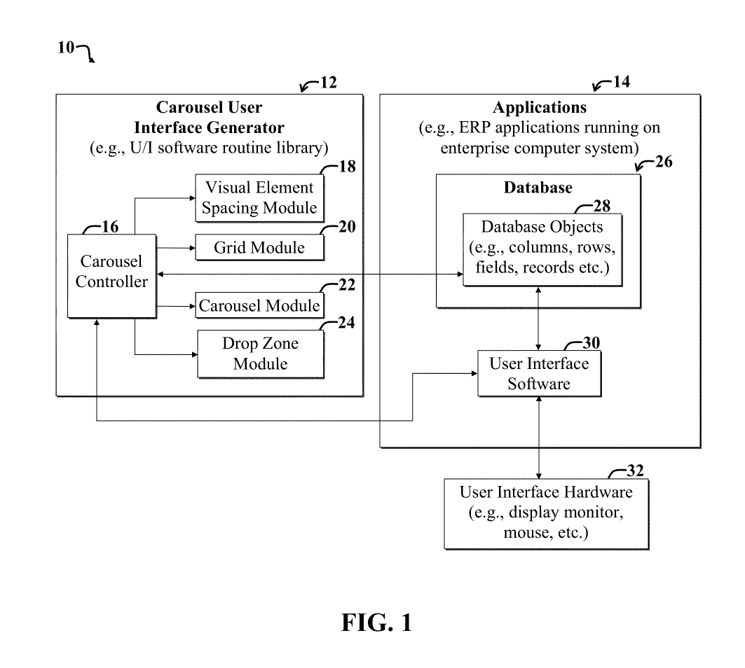

FIG. 1 is a diagram illustrating a first example embodiment of a system 10 for facilitating displaying and organizing data via an adjustable activity carousel displayed via a user interface display screen 32.

For the purposes of the present discussion, a carousel view (also simply called carousel) may be any organization of visual elements in a user interface display screen, whereby overlap may occur between visual elements, and where the visual elements may be scrolled or shifted. An adjustable activity carousel may be any carousel that is readily modifiable by an end user or viewer of the carousel. In certain instances, the term “adjustable activity carousel” is further taken to include user interface features for adjusting spacing between visual elements; for switching between grid views and carousel views wherein visual elements are displayed in a band; and for hiding visual elements or otherwise personalizing display of visual elements in a grid or carousel view.

The example system 10 includes a carousel generator module 12 in communication with one or more applications 14, such as Enterprise Resource Planning (ERP) applications. The example applications 14 include a database application 26, which maintains various computing objects 28. User interface software 30 communicates with the database 26 and user interface hardware 32. The user interface hardware 32 may include a computer display, e.g., monitor, keyboard, computer mouse, and so on, for interacting with the applications 14 via the user interface software 30.

The user interface software 30 has been adjusted to selectively call or invoke functionality provided by the carousel generator 12 to facilitate organizing and displaying (via the user interface hardware 32) visual representations of one or more of the objects 28. The example carousel generator 12 includes a controller 16 in communication with a grid module 20, a carousel module 22, a drop zone module 24, and a visual element spacing module 18. The controller 16 interfaces the modules 18-24 with the user interface software 30 of the applications 14.

In an example operative scenario, a user employs the user interface hardware 32 to navigate data objects 28 via the user interface software 30. When a user navigates to a portion or page of the software 30 that is adapted to present information via a carousel, then the user interface software 30 calls one or more software routines of the carousel software 12 to facilitate obtaining instructions for rendering visual elements corresponding to one or more of the objects 28.

User interface functionality provided by the carousel generator 12 is represented by code (e.g., as provided in the visual element spacing module 18) for enabling a user interface option to adjust spacing between visual elements (e.g., icons or object representations) of a carousel, thereby enabling seamless transition between a stacked presentation of visual elements or a spaced presentation of the visual elements (called a filmstrip view); code (e.g., as provided by the grid module 20 and the carousel module 22) for enabling switching between a grid view and a carousel view; and code (e.g., as provided via the drop zone module 24) for enabling a user to selectively hide or reorder visual elements in the grid view or carousel view.

For the purposes of the present discussion, a filmstrip view may be any organization of visual elements in a user interface display screen, whereby substantially no overlap occurs between visual elements, and one or more user interface controls are provided to enable scrolling of the visual elements to impart the impression that the visual elements are shifting along a line.

A drop zone may be any region of a user interface display screen to where one or more visual elements or other user interface elements or components may be dragged to initiate an action. A example actions include hiding, storing, deleting, and repositioning of the user interface element that was dragged to the drop zone.

Note that while the carousel module 12 is shown as a separate module, the carousel module 12 and associated functionality may be integrated into one or more of the applications 14, such as the user interface software 30, without departing from the scope of the present teachings. In general, the carousel generator 12 may be implemented via one or more computer functions, procedures, and so on, and the functionality may be distributed among resources of a network or consolidated into a single module without departing from the scope of the present teachings.

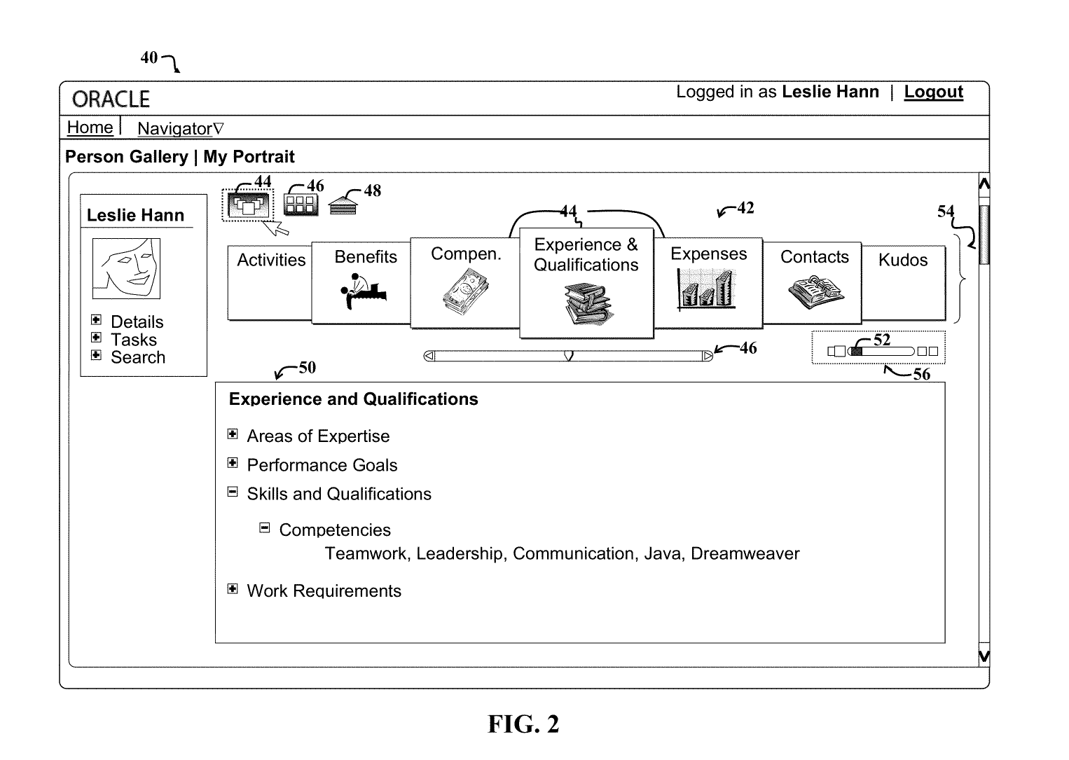

FIG. 2 is a first example user interface display screen 40 illustrating an adjustable activity carousel 42 in a carousel mode or stacked mode, wherein spacing between visual elements 44 in the carousel 42 has been minimized via an element spacing slider bar 56 and accompanying slider 52.

A scroll bar 46 is positioned below a band 54 of the carousel 42. The scroll bar 46 provides a user option to shift the various display elements 44 within the band 54 of the carousel 42. In the present specific embodiment, the display element (e.g., Experience and Qualifications) that is centered on the carousel is enlarged relative to other display elements, and data associated with the display element is organized and presented below the carousel 42 in an object details display section 50.

In the present example embodiment, display of the carousel 42 may be triggered via user selection of a carousel button 44 near the upper left portion of the display screen 40. A grid button 46 is positioned adjacent to the carousel button 44, and a drop zone button 48 is positioned adjacent to the grid button 46. Note that the buttons 44-48 may be implemented via tabs or other user interface controls or mechanisms without departing from the scope of the present teachings. Furthermore, in certain implementations, the drop zone control 48 only appears after a user has selected the grid button 46.

The spacing slider bar 56 provides a user option to drag a slider 52 to adjust spacing between the various visual elements 44 of the carousel 42. As the slider 52 is moved to the right, the spacing between the visual elements 44 increases. The spacing may be expanded so that no overlap between adjacent visual elements 44 exists in the display, resulting in a filmstrip view, also called a flat view. Hence, the slider bar 56 facilitates seamless transition between carousel (or stacked) views and filmstrip or swim lane views.

Note that in alternative implementations, such as implementations using touch screens, the spacing slider bar 56 may be omitted. Instead, certain finger gestures made on the touch screen surface may effectively cause expansion or contraction of spacing between the visual display elements 44. For example, a motion separating fingers may expand the spacing, while a pinching motion may reduce the spacing between the visual elements 44.

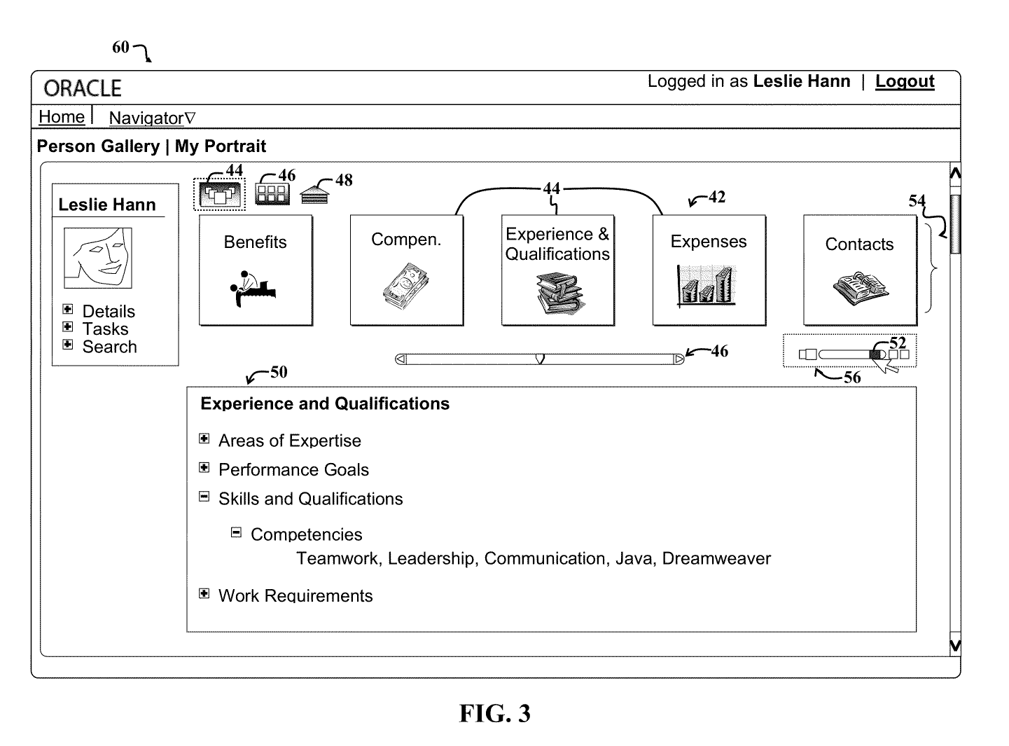

FIG. 3 is a second example user interface display screen 60 illustrating the adjustable activity carousel 42 in a swim lane or flat mode, wherein spacing between visual elements 44 in the carousel has been maximized via the adjustable slider bar 56 and accompanying slider 52. In the user interface display screen 60, a user has moved the slider 52 to the far right of the slider bar 56 to maximize the spacing between the visual elements 44 of the carousel 42.

Note that while in the present example embodiment, the centered visual element (Experience and Qualifications) represents the selected visual element (corresponding data of which is displayed in object details display section 50 below the carousel), other mechanisms for selecting visual elements 44 may be employed. For example, in certain implementations, a user may move a mouse over various visual display elements 44 to cause data associated with the various visual display elements 44 to appear in the object details display section 50.

The drop zone user interface control 48 is adapted to enable a user to drag one or more of the visual elements 44 to the drop zone control 48 to thereby effectively hide the one or more visual elements 44 from view, such that they do not appear in the carousel 42. User selection of the drop zone control 48 may activate display of visual elements that have been hidden from one or more views, such as the carousel view (i.e., the current view) or grid view (as discussed more fully below).

Note that in certain implementations, functionality associated with the drop zone 48 is only available when the grid button 46 has been selected, and when visual elements are displayed in a grid as opposed to a carousel. In such implementations, the drop-zone control 48 may be whited out when the user interface display screen 60 is not in grid view.

Furthermore, note that, in the present example embodiment, sizes of the visual elements 44 may be automatically adjusted based on the available display area and the spacing between the display elements as reflected by the position of the slider bar 52 of the slider bar 56.

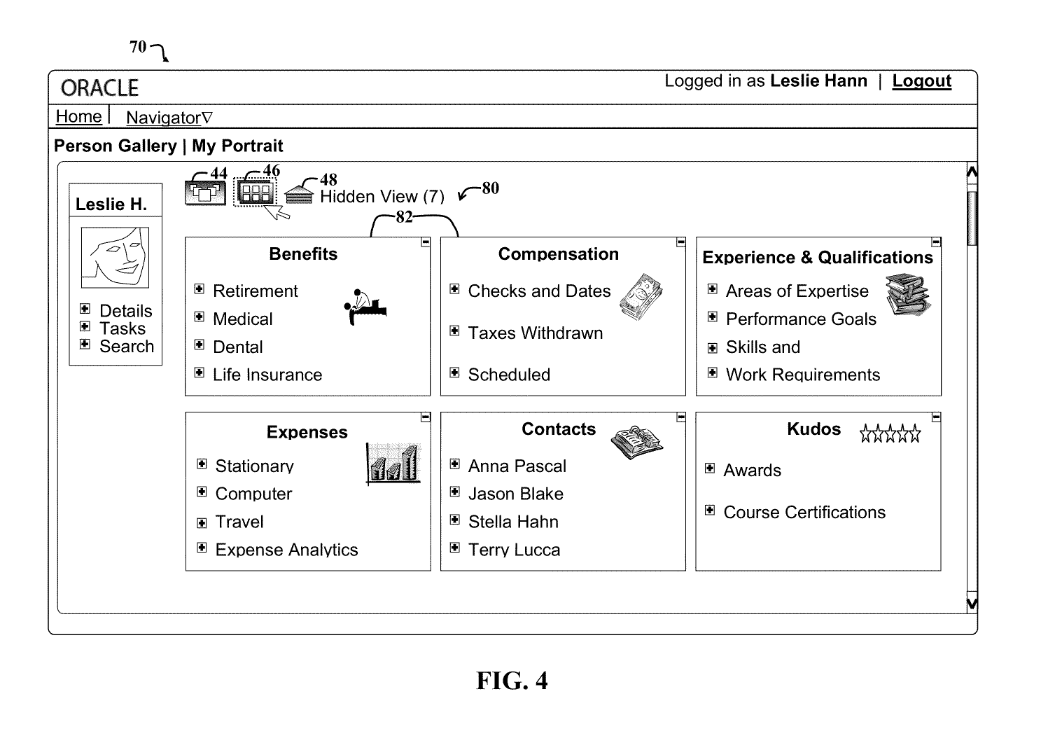

FIG. 4 is a third example user interface display screen 70 illustrating visual elements 82 in a grid view 80 after selection of a grid-view button or tab 46 from the user interface display screens 40, 60 of FIG. 2 or 3.

In the present example embodiment, the various visual elements 82 correspond to visual elements 44 of the carousels 42 of FIGS. 2-3. The visual elements 82 may be dragged and repositioned in the grid, which may effectively reposition the corresponding display elements in the carousel 42 of FIGS. 2-3. Note that the carousel 42 is accessible via selection of the carousel button or tab 44.

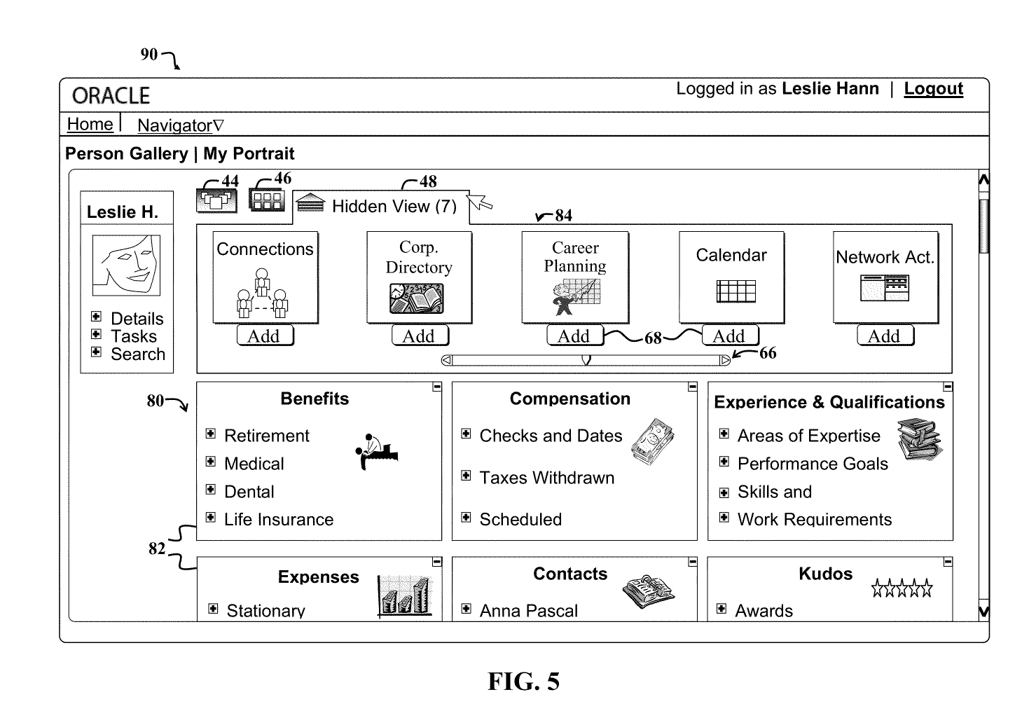

The drop zone control 48 illustrates, for example, that seven visual elements have been hidden, e.g., by dragging one or more of the visual elements 82 onto the drop zone control 48, or by first expanding the drop zone control 48, and then dragging one or more visual elements 82 onto the expanded drop zone control, as discussed more fully below with reference to FIG. 5.

FIG. 5 is a fourth example user interface display screen illustrating a drop zone section 84, which appears after selection of the drop zone control 48 from the user interface display screens 70, 90 of FIG. 4 or FIG. 5. In certain implementations, the drop zone section 84 automatically appears when a visual element is dragged from the grid section 80 onto the drop zone user interface control 48.

Various visual elements 64 are positioned in the drop zone section 84 in a swim lane or carousel band equipped with a scroll bar 66. Various visual elements 64 represent visual elements that have been hidden from a grid and/or carousel view.

In the present example embodiment, visual elements 64 appearing in the drop zone section 84 have been dragged and dropped there from the grid section 80 below. Visual elements that have been placed in the drop zone section 84 from the grid section 80 may automatically be hidden from carousel views accessible via the carousel button or tab 44.

The various visual elements 64 in the drop zone section 84 include add buttons 68 to enable restoration of the corresponding visual elements to the grid and carousel views.

Hence, certain embodiments disclosed herein enable switching or toggling between display of visual elements in a grid view or adjustable carousel view. Spacing between elements of the carousel is readily adjustable via a slider or other mechanism. The spacing may be adjusted sufficiently to enable seamless transition between swim lane representations of visual elements (where the elements may have similar visual weights, e.g., sizes) to stacked or carousel representations of the visual elements.

Various embodiments discussed herein may present integrated carousel, swim lane (filmstrip), and grid views, where transitions between views may occur via a single click or other user input. Furthermore, use of a drop zone and grid view as discussed herein may facilitate user personalization of how information is displayed.

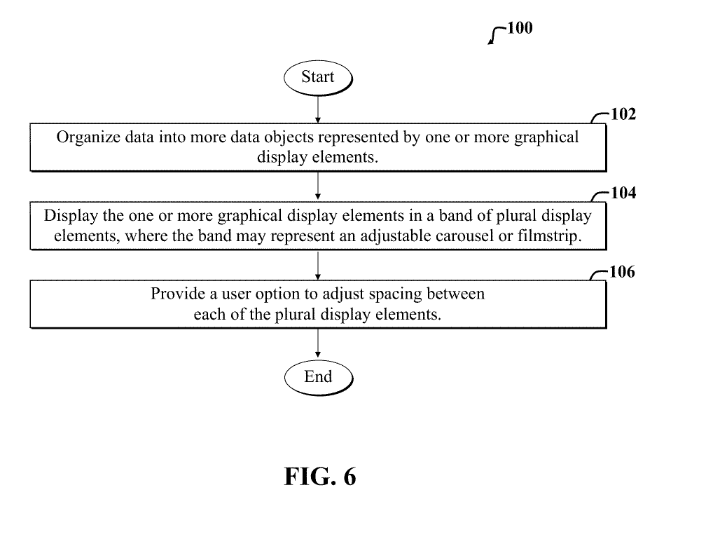

FIG. 6 is a flow diagram of an example method 100 adapted for use with the embodiments of FIGS. 1-5.

The example method 100 includes a first step 102, which involves organizing data into one or more data objects represented by one or more graphical display elements, also called visual elements herein.

A second step 104 includes displaying the one or more graphical display elements in a band of plural display elements, where the band may represent an adjustable carousel, swim lane, or filmstrip.

A third step 106 includes providing a first user option to adjust spacing between each of the plural display elements.

The method 100 may be modified or augmented without departing from the scope of the present teachings. For example, an additional step may include providing a user option to reduce the spacing to cause overlap of one or more of the plural display elements within the display band. In this case, the spacing may be sufficiently adjustable to allow seamless transitioning between a stacked carousel view and a flat filmstrip view of the plural display elements.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for selectively displaying data, the method comprising:
organizing data into one or more data objects represented by one or more graphical display elements;
displaying the one or more graphical display elements in a band of plural display elements; and
providing a first user option to simultaneously adjust spacing between each of the plural display elements in the band.

2. The method of claim 1, wherein providing a first user option further includes providing a user option to reduce the spacing to cause overlap of one or more of the plural display elements within the display band.

3. The method of claim 2, further including providing a user option to adjust spacing to cause no overlap between one or more of the plural display elements.

4. The method of claim 1, wherein providing the first user option further includes providing a user option to convert the band with plural display elements into a carousel view or to a filmstrip view by adjusting the spacing.

5. The method of claim 1, further including providing a second user option to display one or more of the plural display elements in a grid.

6. The method of claim 5, further including providing a user option to switch between display of graphical display elements in a grid and display of graphical display elements in the band.

7. The method of claim 6, further including providing a third user option to hide one or more of the graphical display elements from view in the grid.

8. The method of claim 6, wherein the third user interface option includes a drop zone user interface control.

9. The method of claim 8, wherein the drop zone user interface control is adapted to display one or more graphical display elements that have been hidden from a grid or a band upon selection of the user interface control.

10. The method of claim 8, wherein the drop zone user interface control is adapted to cause hiding of a graphical display element from a grid or a band when a graphical display element is dragged from a grid or band to the drop zone.

11. The method of claim 1, further including providing a third user interface option to remove one or more of the graphical display elements from being displayed in the band.

12. The method of claim 1, further including providing a first user interface control for activating display of one or more graphical user interface elements in a band.

13. The method of claim 12, further including providing a second user interface control for activating display of one or more graphical user interface elements in a grid.

14. The method of claim 13, further including providing a third user interface control for activating display of one or more graphical display elements that are hidden from the grid or the band.

15. The method of claim 14, wherein the grid is adapted to enable one or more graphical display elements shown in the grid to be repositioned in the grid, resulting in repositioned graphical display elements in response thereto.

16. The method of claim 14, wherein the band is adapted to order display of graphical display elements in the band according to an order in which the graphical display elements appear in the grid.

17. The method of claim 1, further including providing a user option to transition displaying the graphical display elements in a band to displaying the graphical display elements in a grid.

18. The method of claim 17, further including selectively automatically resizing one or more graphical display elements based on spacing between two or more of the graphical display elements.

19. An apparatus comprising:
a digital processor coupled to a display and to a processor-readable storage device, wherein the processor-readable storage device includes one or more instructions executable by the digital processor to perform the following acts:
organizing data into one or more data objects represented by one or more graphical display elements;
displaying the one or more graphical display elements in a band of plural display elements; and
providing a first user option to adjust spacing between each of the plural display elements.

20. A processor-readable storage device including instructions executable by a digital processor for modifying a workplace decision-making hierarchy, the processor-readable storage device including one or more instructions for:
organizing data into one or more data objects represented by one or more graphical display elements;
displaying the one or more graphical display elements in a band of plural display elements; and
providing a first user option to adjust spacing between each of the plural display elements.
